(19) United States
(12) Patent Application Publication
(10) Pub. No.: US 2017/0168208 A1
(43) Pub. Date: Jun. 15, 2017

(54) FLUORESCENT LED BACKLIGHT PLATE ASSEMBLY

(71) Applicant: Chih-Wei Wu, Miaoli city (TW)

(72) Inventor: Chih-Wei Wu, Miaoli city (TW)

(21) Appl. No.: 14/967,347

(22) Filed: Dec. 13, 2015

(51) Int. Cl. F21V 8/00

(52) U.S. Cl. CPC G02B 6/005; G02B 6/0055; G02B 6/0068

(57) ABSTRACT

A fluorescent LED backlight plate assembly includes: at least one LED bar containing blue LED light sources; a light guide plate aside the LED light bar; a light reflecting sheet below the light guide plate; a light processing module located above the light guide plate; the light processing module containing a plurality of light processing plates and a fluorescent plate containing green and red fluorescent material. When red fluorescent and green fluorescent materials are stimulated, they emit red and green lights, so that light intensity is enhanced. Thus, when these light further passes through an LCD panel, they will present high light intensity and saturation. In another embodiment, no fluorescent plate is used, while fluorescent materials are added to the light guide plate or the light processing plates. The fluorescent materials contain red and green fluorescent materials.

### FIELD OF THE INVENTION

The present invention relates to LED backlight plates; and in particular to a fluorescent LED backlight plate assembly.

### BACKGROUND OF THE INVENTION

A conventional LED backlight plate mainly contains at least one LED light bar, a light guide plate, a light reflecting sheet and a light processing module. The LED light bar comprises a plurality of LED light sources for light emission. The light guide plate is located aside the LED light bar for receiving light from the LED light bar and thus guiding the light along a surface of the light guide plate. The LED light bar is below the light guide plate for reflecting light from the light guide plate and then passes through the light guide plate to be transferred upwards. A light processing module is at an upper side of the light guide plate. The light processing module comprises a plurality of light processing plates for processing light from the light guide plate towards the light processing module so as to present a desire effect. The light processing plates may be light expansion plates, rhombus glass plates, or light polarized plates, etc.

In many situations, it is desired that LCD displays have high intensities, such as high resolution displays, however, the higher the resolution, the lower the light transmission ratios. Furthermore for daytime displaying, LCD displays require higher intensities. For conventional LED backlight plates, red and green lights are low intensities and thus they have lower transmission rate. After passing through the light guide plate and light processing module, the red and green lights are decayed dramatically. Thus when these lights further pass through an LCD panel, intensities and saturations of red and green lights have bad qualities. Lights are weak and have lower intensities. They cannot achieve requirements of high resolution TVs and being used in daytime.

### SUMMARY OF THE INVENTION

To improved above mentioned defects in the prior art, the present invention provides a fluorescent LED backlight plate assembly, wherein a fluorescent plate is added to the LED backlight plate, which can be added to an upper side of the light guide plate or any light processing plate in the light processing module. The LED light source in the LED light bar is blue light source. The fluorescent material contains green and red fluorescent materials. When light from the LED light bar passed through the fluorescent materials, the fluorescent materials will be stimulated so as to emit red and green lights which are stronger and saturated. Then these red and green lights pass through an LED panel, they still retain high intensities and high saturations so as to present colors of high quality. As a result, the image on the panel has high resolution and the image is clear in daytime. Therefore, the conventional problem of low light intensities and low saturation in the conventional LCD panels are improved.

For achieve above object, the present invention provides a fluorescent LED backlight plate assembly at least one LED bar containing a plurality of LED light sources which includes blue LED light source; a light guide plate aside the LED light bar; light emitted from the LED light bar will be incident into the light guide plate and transferring along a surface of the light guide plate. a light reflecting sheet below the light guide plate; light dispersed from the light guide plate being reflected by the light reflecting sheet to be incident upwards; a light processing module located above the light guide plate; the light processing module containing a plurality of light processing plates for further processing the light from or passing through the light guide plate; and a fluorescent plate containing green and red fluorescent material for presenting yellow color; wherein when red fluorescent and green fluorescent materials are stimulated, they emit red light and green light, so that light intensity directly from the fluorescent plate is stronger and thus, when these light further passes through an LCD panel, they will present high light intensity and saturation.

In another embodiment, no fluorescent plate is used, while fluorescent materials are added to the light guide plate or the light processing plates. The fluorescent materials contain red and green fluorescent materials.

### BRIEF DESCRIPTION OF THE DRAWINGS

FIG. 1 is an exploded view of the first embodiment of the present invention.

FIG. 2 is an assembly cross sectional view in the first embodiment of the present invention.

FIG. 3 shows one application of the present invention in the embodiment, where an LCD panel is used.

FIG. 4 shows another application of the present invention, where two LED light bars are used.

FIG. 5 is an exploded view of the second embodiment of the present invention.

FIG. 6 is an assembly cross sectional view of the second embodiment of the present invention.

FIG. 7 shows another application of the second embodiment present invention, where two LED light bars are used.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

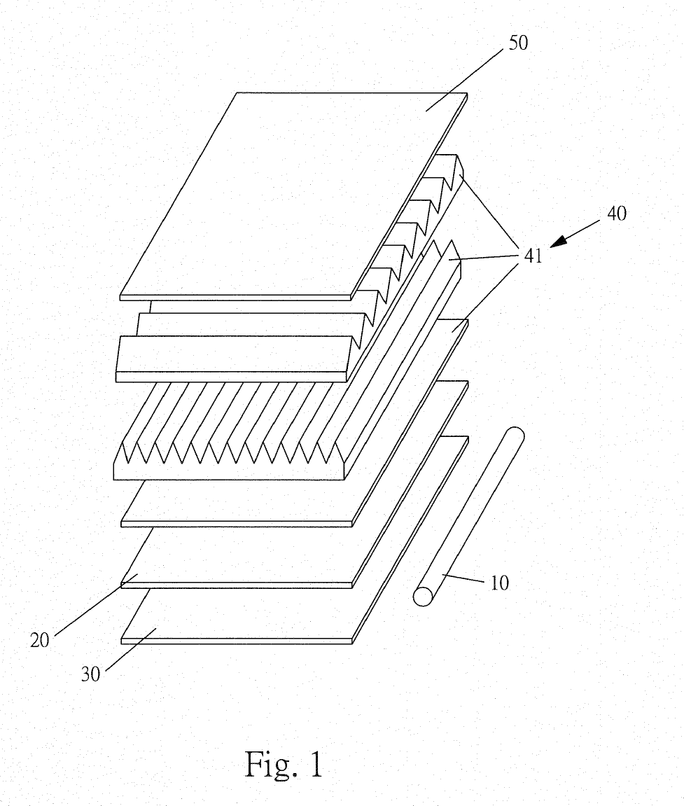

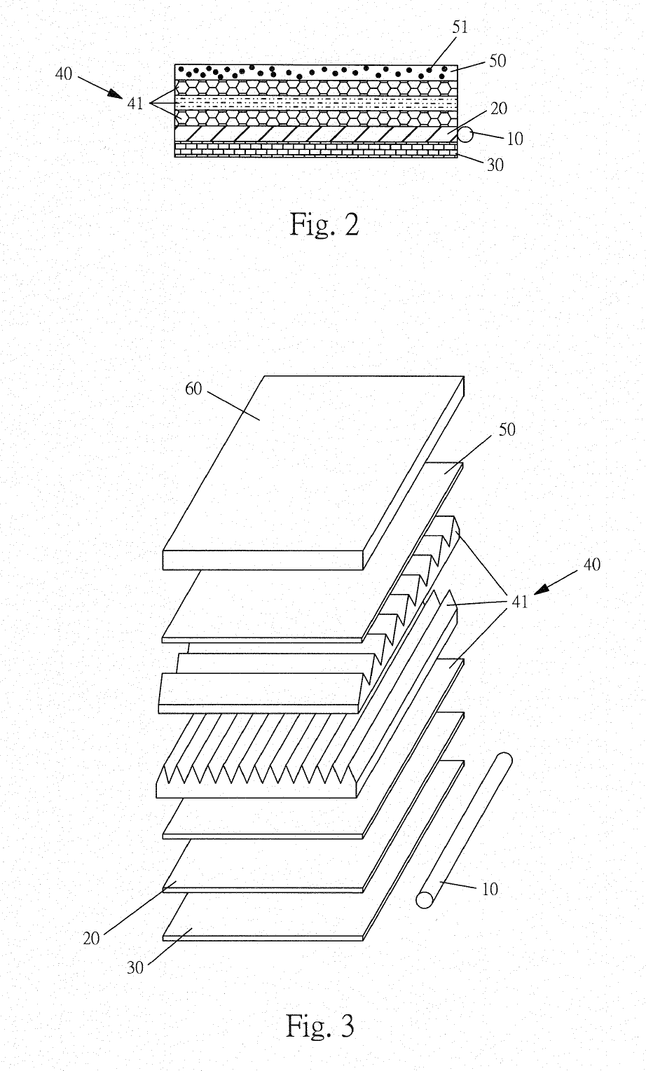

With reference to FIGS. 1 to 4, the first embodiment of he present invention will be described herein. The LED backlight plate containing fluorescent materials of the present invention has the following elements.

At least one LED bar 10 contains a plurality of LED light sources which includes blue LED light source.

A light guide plate is aside the LED light bar. Light emitted from the LED light bar will be incident into the light guide plate and transfers along the surface of the light guide plate. In one application, a side of the light guide plate near the LED light bar may be textured for concentrating light from the LED light bar.

A light reflecting sheet 30 is below the light guide plate 20. Light dispersed from the light guide plate 20 will be reflected by the light reflecting sheet 30 to be incident upwards.

A light processing module 40 is located above the light guide plate 20. The light processing module 40 contains a plurality of light processing plates 41 for further processing the light from or passing through the light guide plate 20 so that the light may be usable as desired. The light processing module 40 may be light expansion sheets, rhombus light glasses, light polarization plates, etc.

A fluorescent plate contains green and red fluorescent material (having fluorescent powders or phosphor powders) for presenting yellow color. When red fluorescent and green fluorescent materials are stimulated, they emit red light and green light, so that light intensity directly from the fluorescent plate is stronger and thus, when these light further passes through an LCD panel, they will present high light intensity and saturation.

In the present invention, the fluorescent plate 50 is located above the light guide plate 20 or be inserted into the light processing module 40. Preferably, the fluorescent plate 50 is located above the uppermost light processing plate 41 of the light processing module 40 so that after assembly, the fluorescent plate 50 is very near the LED panel.

Preferably, the fluorescent plates 50 are acrylic plates or PC plates.

With reference to FIG. 3, in this application, an LED panel 60 is located above the fluorescent plate 50 so that light passes through the fluorescent plate 50 will enter into the LED panel 60 directly so as to generate required light effect.

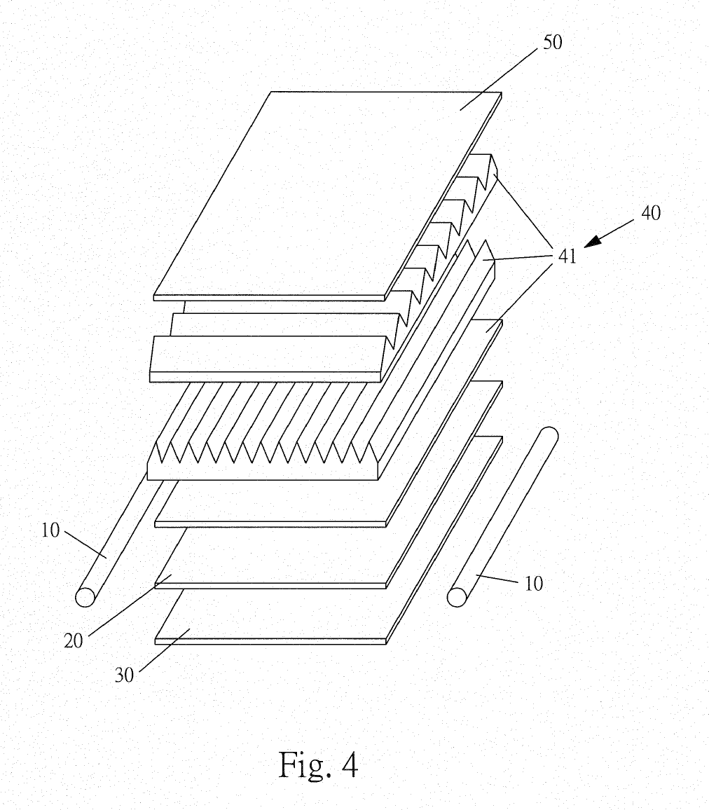

With reference to FIG. 4, in this application, two LED light bars 10 are used, which are located at two lateral sides of the light guide plate 20.

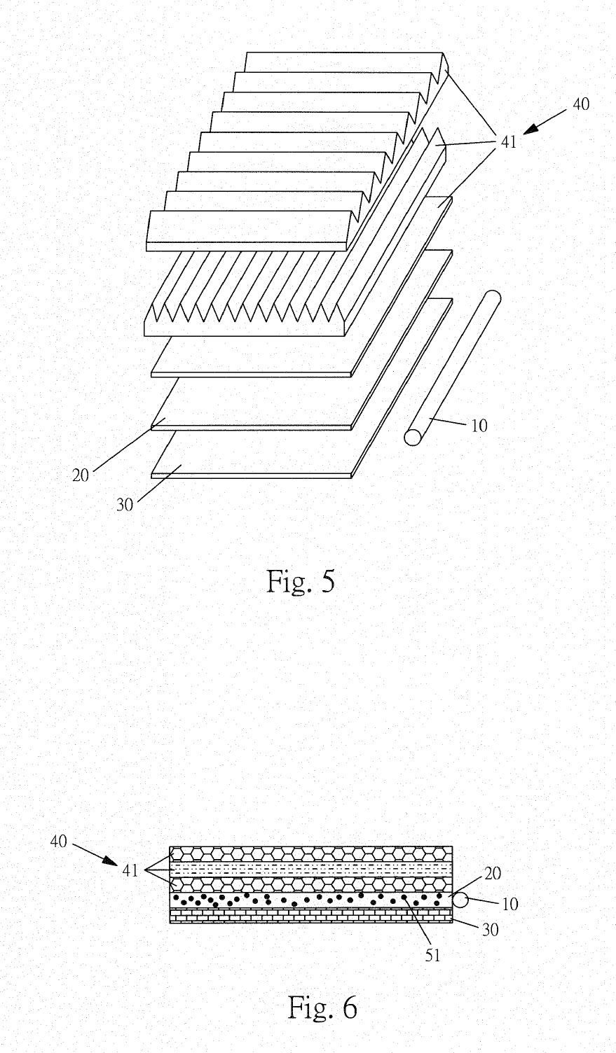

With reference to FIGS. 5 to 7, the second embodiment of the present invention is illustrated. In this embodiment, those elements identical to those in the first embodiment are identified by the same numerals.

In the second embodiment, the backlight plate of the present invention comprises:

At least one LED bar 10 contains a plurality of LED light sources which includes blue LED light source.

A light guide plate 20 is aside the LED light bar 10. Light emitted from the LED light bar 10 will be incident into the light guide plate 20 and transfers along the surface of the light guide plate 20. In one application, a side of the light guide plate 20 near the LED light bar 10 may be textured for concentrating light from the LED light bar 10.

A light reflecting sheet 30 is below the light guide plate 20. Light dispersed from the light guide plate 20 will be reflected by the light reflecting sheet 30 to be incident upwards.

A light processing module 40 is located above the light guide plate 20. The light processing module 40 contains a plurality of light processing plates 41 for further processing the light from or passing through the light guide plate 20 so that the light may be usable as desired. The processing module 40 may be light expansion sheets, rhombus light glasses, light polarization plates, etc.

In this embodiment, one of the light guide plate 20 and the light processing plates 41 of the light processing module 40 contains fluorescent materials (having fluorescent powders or phosphor powders). The fluorescent material is mixed with materials of the light guide plate 20. Preferably, the fluorescent material 50 is mixed with the material of the uppermost light processing plates 41 of the light processing module 40. The fluorescent material containing green and red fluorescent material so that the light processing plate 41 containing the fluorescent materials 50 present yellow color as light passed therethorugh. The red and green fluorescent materials are stimulated so as to emit red light and green light which generates yellow light. Light intensity directly from the fluorescent materials are stronger and thus, when this light further passes through an LCD panel will present high light intensity and high saturation.

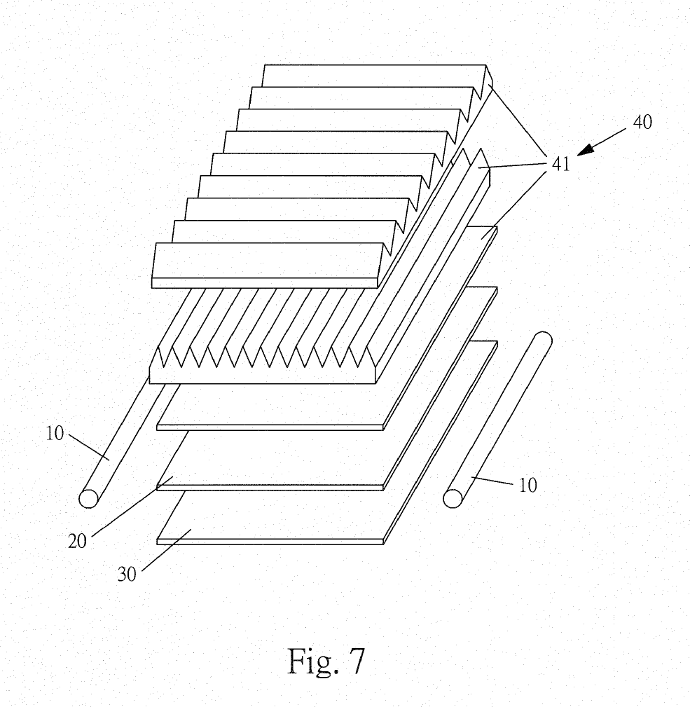

With reference to FIG. 7, in this embodiment, two LED light bars 10 are used, which are located at two lateral sides of the light guide plate 20.

Advantages of the present invention are that: a fluorescent plate is added to the LED backlight plate, which can be added to an upper side of the light guide plate or any light processing plate in the light processing module. The LED light source in the LED light bar is blue light source. The fluorescent material contains green and red fluorescent materials. When light from the LED light bar passed through the fluorescent materials, the fluorescent materials will be stimulated so as to emit red and green lights which are stronger and saturated. Then these red and green lights pass through an LED panel, they still retain high intensities and high saturations so as to present colors of high quality. As a result, the image on the panel has high resolution and the image is clear in, daytime. Therefore, the conventional problem of low light intensities and low saturation in the conventional LCD panels are improved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A fluorescent LED backlight plate assembly comprising:
at least one LED bar containing a plurality of LED light sources which includes blue LED light source;
a light guide plate aside the LED light bar; light emitted from the LED light bar will be incident into the light guide plate and transferring along a surface of the light guide plate;
a light reflecting sheet below the light guide plate; light dispersed from the light guide plate being reflected by the light reflecting sheet to be incident upwards;
a light processing module located above the light guide plate; the light processing module containing a plurality of light processing plates for further processing the light from or passing through the light guide plate; and
fluorescent plate containing green and red fluorescent material;
wherein when red fluorescent and green fluorescent materials are stimulated, they emit red light and green light, so that light intensity is enhanced and thus, when these light further passes through an LCD panel, they will present high light intensity and saturation, wherein the fluorescent material contains fluorescent powders or phosphor powders.

2. The fluorescent LED backlight plate assembly as claimed in claim 1, wherein the fluorescent plate is located above the light guide plate.

3. The fluorescent LED backlight plate assembly as claimed in claim 1, wherein the fluorescent plate is inserted into the light processing module.

4. The fluorescent LED backlight plate assembly as claimed in claim 1, wherein the fluorescent plate is located above an uppermost light processing plate of the light processing module.

5. The fluorescent LED backlight plate assembly as claimed in claim 1, wherein the fluorescent plates are acrylic plates or PC plates.

6. The fluorescent LED backlight plate assembly as claimed in claim 1, further comprising an LED panel located above the fluorescent plate so that light passes through the fluorescent plate will enter into the LED panel directly so as to generate required light effect.

7. The fluorescent LED backlight plate assembly as claimed in claim 1, wherein two LED light bars are used, which are located at two lateral sides of the light guide plate.

8. The fluorescent LED backlight plate assembly as claimed in claim 1, wherein a side of the light guide plate near the LED light bar is textured for concentrating light from the LED light bar.

9. The fluorescent LED backlight plate assembly as claimed in claim 1, wherein the light processing module is one of light expansion sheets, rhombus light glasses, and light polarization plates.

10. A fluorescent LED backlight plate assembly, comprising:
at least one LED bar containing a plurality of LED light sources which includes blue LED light source;
a light guide plate aside the LED light bar; light emitted from the LED light bar will be incident into the light guide plate and transferring along a surface of the light guide plate;
a light reflecting sheet below the light guide plate; light dispersed from light guide plate being reflected by the light reflecting sheet to be incident upwards;
a light processing module located above the light guide plate; the light processing module containing a plurality of light processing plates for further processing the light from or passing through the light guide plate; and
a fluorescent plate containing green and red fluorescent material; wherein when red fluorescent and green fluorescent materials are stimulated, they emit red light and green light, so that light intensity is enhanced and thus, when these light further passes through an LCD panel, they will present high light intensity and saturation, wherein the fluorescent material containing fluorescent powders or phosphor powders.

11. The fluorescent LED backlight plate assembly as claimed in claim 10, wherein the fluorescent material is mixed with material of the light guide plate.

12. The fluorescent LED backlight plate assembly as claimed in claim 10, wherein the fluorescent plate is mixed with material of a selected one of the light processing plates.

13. The fluorescent LED backlight plate assembly as claimed in claim 10, wherein the fluorescent plates are acrylic plates or PC plates.

14. The fluorescent LED backlight plate assembly as claimed in claim 10, further comprising an LED panel located above the fluorescent plate so that light passes through the fluorescent plate will enter into the LED panel directly so as to generate required light effect.

15. The fluorescent LED backlight plate assembly as claimed in claim 10, wherein two LED light bars are used, which are located at two lateral sides of the light guide plate.

16. The fluorescent LED backlight plate assembly as claimed in claim 10, wherein a side of the light guide plate near the LED light bar is textured for concentrating light from the LED light bar.

17. The fluorescent LED backlight plate assembly as claimed in claim 10, wherein the light processing module is one of light expansion sheets, rhombus light glasses, light polarization plates.
